(19) United States
(12) Patent Application Publication
(10) Pub. No.: US 2005/0027577 A1
(43) Pub. Date: Feb. 3, 2005

(54) Architecture for general purpose business planning optimization system and methods therefor

(76) Inventor: Baruch I. Saeed, Berkeley, CA (US)

Correspondence Address: IPSG, P.C., P.O. BOX 700640, SAN JOSE, CA, 95170-0640, US

(21) Appl. No.: 10/631,409

(22) Filed: Jul. 30, 2003

(51) Int. Cl. G06F 17/60

(52) U.S. Cl. 705/8

(57) ABSTRACT

A method of optimizing the allocation of a set of resources within a business organization, in a substantially automated manner. The method includes creating a model of a set of products, a set of processes and a set of projects, wherein the business organization comprises the products, the processes and the projects; and creating a set of mathematical relationships between the products, the processes and the projects for a set of time periods. The method also includes determining a first set of parameter values to describe the products and the processes and the projects in the model for the set of time periods; determining a set of substantially optimal allocations of the set of resources using mathematical optimization techniques; and, prioritizing the set of a set of substantially optimal allocations based on a business criteria. And, if required, the method further includes modifying the model with the set of substantially optimal allocations

### BACKGROUND OF THE INVENTION

The present invention relates in general to enterprise information systems. More particularly, the present invention relates to an architecture and methods for optimizing business planning.

Business planning is typically the process of acquiring operational information from business units (e.g., across departments, divisions, and locations) in order to first create, and then integrate, and finally execute the next series of operational plans and financial budgets. The process normally entails that each logical organization of the business (e.g. lab, department, division) gathers information from logical sub-organizations, which in turn, themselves gather information from their sub-organizations, to a desired level of abstraction, usually at products and processes.

The business information must often aggregated from multiple data sources, such as from individual spreadsheets, OLTP applications, and from specialized databases, called operational data stores. OLTP (online transaction processing) applications are those enterprise systems that manage a company's basic transactions, such supply chain management (SCM), customer relationship management (CRM), and enterprise resource planning (ERP).

Business manager must correctly make decisions that optimize resource allocation in order to maximize profits (and minimize the potential for bad financial news.) For example, key decisions include determining which new products to introduce, which suppliers to use, which capital investments to make, and what prices to charge.

Timely analysis of information is critical, since delays in aggregation and analysis reduces both reliability and relevancy. The typical business planning process, however, is often bureaucratic, inefficient, and time consuming. The process must be orchestrated among multiple organizations, each of which may have its own information tracking and planning model (often created or recreated in a spreadsheet). Furthermore, assumptions built into these models of individual business units may, themselves be incompatible (i.e., cost of labor, standard material cost, yield etc.).

Employees fail to connect their decisions to the underlying economics of the business. Although sophisticated tools are available (e.g., spreadsheets, activity-based costing systems, and simulation and optimization packages, etc.), the solutions are piecemeal, and fail to capture the myriad of interconnections and hidden dynamics that collectively formed the underlying economics of the business.

Subsequently, the process is too time consuming to execute more than once in a planning cycle. This means that the resulting analysis does not substantially reflect the underlying business reality. Employees are instead focused on misaligned objectives and management wish lists, instead of solving the hidden root causes of problems. Furthermore, employees tend to work on issues in an ad-hoc way, usually relying on intuition and recent experiences—often from major crises—to guide them. Even when they work on important issues, they develop many ideas but only implement a few. Ideas are rarely retained for future consideration.

Business units, unsure of the analysis, often pad their budgets in order to hit the planned targets. In addition, because decision-making involves extensive human analytical effort and negotiation time, employees rarely rethink major decisions, updating them only during crises or when forced to through annual and, perhaps, quarterly reviews.

To facilitate discussion, FIG. 1 shows a simplified functional diagram of a typical business planning process. There are commonly 4 discrete phases: model (102), parameterize 104, optimize 106, learn 108. The model 102 phase comprises the creation of a representation of a business organization's products, processes, and projects. This phase can also further be adjusted with information derived from the previous learn 108 phase.

Products are commonly composed of factors of production (or intermediate products), and finished goods. For example, a car (a finished good) is composed of tires, steel, engines, labor, and electricity (factors of production). Processes are elements that act, modify, and or transform products. For example, an auto manufacturing line is composed of a stamping machine, a welding machine, and a painting machine.

The parameterize 104 phase comprises adjusting the representation with actual and forecasted business data. For example, a car (finished good) is composed of 4 tires, 500 lbs. of steel, 1 engine, 200 hours of labor, and 1 kW of electricity (factors of production). An auto manufacturing line is composed of 30 minutes of stamping, 15 minutes of welding, and 10 minutes of painting.

The optimize 106 phase comprises re-allocation of resources. For example, the auto manufacturing line in Mexico should produce a specific car model X. The learn (108) phase comprises an in depth analysis of parameters in order to gain insights. For example, a new SUV should be designed and produced on the auto manufacturing line in Mexico.

Referring now to FIG. 2A., a simplified diagram of a spreadsheet approach to business planning is shown, in which operational information is often downloaded and manually manipulated in user created (or recreated) spreadsheets. Each task is composed of a specific business planning process phase (e.g., model 102), parameterize 104, optimize 106, learn 108) as previously described. Each task is further organized in a logical level of abstraction within the business's operational architecture: business application layer 202, user interface layer 204, and user interaction layer 206. Business application layer 202 comprises the core business operation systems such as ERP, CRM, and SCM, as previously described.

In model phase 102 of FIG. 2A, users build many, inconsistent, economically-invalid spreadsheets, missing many dynamics 222. Dynamics are complex inter-relationships between and among products and processes, such as lead-times, demand variability and supplier reliability. Users often do not understand these dynamics, or are unable to create a usable spreadsheet model that reasonably captures the dynamics. In the parameterize phase 104, users then estimate and enter all known parameters, perhaps using some simple statistical analyses. Users do not enter values for the “hidden,” unknown dynamics 224. For example, in determining the cost of an automobile engine, an approximate product cost (i.e., standard cost) would need to be used since the actual cost relies on a complicated set of factors. These factors include the specific materials used, the costs of those materials, the costs of transporting those materials to the factory and then moving them to the production line, which production line it is product is produced on, etc.

In the optimize phase 106, users then run a small set of scenarios to compare courses of action. In rare cases, they may use spreadsheet “solvers,” or optimization tools, for sub-sets of the courses of action 226. In the learn phase 108 they subsequently creates all exhibits and manually puts them into presentation software 228, using user-directed charting tools 230. Although a spreadsheet is relatively easy to use, spreadsheet-based planning has no unified software architecture, and hence it is inefficient and prone to mistakes. The spreadsheet models may not only differ between business units, but also between different users within the same business unit. Furthermore, other than generating the mathematics on the model phase 102, the majority of the work is manually done by users. Spreadsheets have no ability to optimize over a very large set of decision variables that describe different decision possibilities, and users can run enough scenarios to assess a tiny fraction of possible courses of action.

Referring now to FIG. 2B., a simplified diagram of an activity-based approach to business planning is shown. Activity-based costing is a costing model that identifies the cost pools, or activity centers, in an organization and assigns costs to products and services (cost drivers) based on the number of events or transactions involved in the process of providing a product or service.

In the model phase 102 of FIG. 2B, a model with consistent mathematics is generated directly from applications in business application layer 230. Although the model may describe the entire enterprise, it also assumes linear, simplistic relationships between and among products and processes. Visual model-building tools often included as part of the application user-interface layer 204. These tools, in turn, are used by users input products, processes, projects and their relationships 238 into the generated model.

In the parameterize phase 104, visual parameter entry tools, also often included as part of the application in business application layer 230, are further used by users to estimate and enter all known parameters. As in task 224 of FIG. 2A, users do not enter values for “hidden,” unknown dynamics 240.

In optimize phase 106, users create and run scenarios to handle different situations 242. For example, elimination of a product line, or reduction of a product price.

In the learn phase 108, report tools, also often included as part of the applications in business application layer 236, are further used by users to estimate and build reports from all known parameters contained in the model. These reports can then be used by users to explore parameters and results 244. Although an activity-based approach is superior to the spreadsheet approach of FIG. 2A (e.g., a directly generated model from business application layer 202, additional user-interface tools, etc.) much of the low-level analytical work must still be manually accomplished by users.

Referring now to FIG. 2C., a simplified diagram of a profit optimization approach to business planning is shown. In the model phase 102 of FIG. 2B, a model with consistent mathematics is generated directly from applications in business application layer 260. Although the model may describe the entire enterprise, it also assumes linear, simplistic relationships between and among products and processes. Visual model-building tools are often included as part of the user-interface layer 266 and are used by users to input products, processes, projects and their relationships 272 into the generated model.

In the parameterize phase 104, visual parameter entry tools, also often included as part of the application in user-interface layer 268, are further used by users to estimate and enter all known parameters. As in task 224 of FIG. 2A, users do not enter values for “hidden,” unknown dynamics 264.

In optimize phase 106, unlike in FIG. 2B, an optimization application in business application layer 202, such as ILOG's CPLEX, optimizes part(s) of enterprise model 262. And although users can redo the optimization as requested, there is no automatic sequencing or prioritization of potential projects. Users can subsequently create and run scenarios to handle different situations 276.

In the learn phase 108, the optimization application identifies marginal values of improvement, although again there is no automatic suggestion of projects 264. Report tools, also often included as part of the applications in business application layer 202, are further used by users to estimate and build reports from all known parameters contained in the model 270. These reports can then be used by users to explore parameters and results 278. Although an activity-based approach is superior to the activity based approach of FIG. 2B (e.g., automated optimization) potential projects must still be manually analyzed and prioritized. In a large organization, for instance, thousands of such projects may be generated.

In view of the foregoing, there is desired an architecture and methods for optimizing business planning in which a business model generated and optimized in a substantially automated manner, and in which potential projects are prioritized also in a substantially automated manner.

### SUMMARY OF THE INVENTION

These and other features of the present invention will be described in more detail below in the detailed description of the invention and in conjunction with the following figures.

The invention relates, in one embodiment, to a method of optimizing the allocation of a set of resources within a business organization, in a substantially automated manner. The method includes creating a model of a set of products, a set of processes and a set of projects, wherein the business organization comprises the products, the processes and the projects; and creating a set of mathematical relationships between the products, the processes and the projects for a set of time periods. The method also includes determining a first set of parameter values to describe the products and the processes and the projects in the model for the set of time periods; determining a set of substantially optimal allocations of the set of resources using mathematical optimization techniques; and, prioritizing the set of a set of substantially optimal allocations based on a business criteria. And, if required, the method further includes modifying the model with the set of substantially optimal allocations

The invention relates, in one embodiment, to an apparatus for optimizing the allocation of a set of resources within a business organization, in a substantially automated manner. The apparatus includes a means for creating a model of a set of products, a set of processes and a set of projects, wherein the business organization comprises the products, the processes and the projects; a means for creating a set of mathematical relationships between the products, the processes and the projects for a set of time periods; and a means for determining a first set of parameter values to describe the products and the processes and the projects in the model for the set of time periods. The apparatus further includes a means for determining a set of substantially optimal allocations of the set of resources using mathematical optimization techniques; and a means for prioritizing the set of a set of substantially optimal allocations based on a business criteria. And if required, the apparatus also includes a means for modifying the model with the set of substantially optimal allocations.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a simplified functional diagram of a typical business planning process;

FIG. 2A illustrates a simplified diagram of a spreadsheet approach to business planning, in which operational information is often downloaded and manually manipulated in user created (or recreated) spreadsheets;

FIG. 2B illustrates a simplified diagram of an activity-based approach to business planning;

FIG. 3 illustrates a simplified diagram of a NanoPlanner optimization approach to business planning, according to one embodiment of the present invention;

FIG. 4 illustrates a simplified diagram of NanoPlanner architecture model phase, according to one embodiment of the invention;

FIG. 5 illustrates a simplified, high-level example of a model with key processes and product flows for a paper company mill, according to one embodiment of the invention;

FIG. 6 illustrates a simplified diagram of the process flow of a digester, according to one embodiment of the invention;

FIG. 7 illustrates a simplified example of the “complexity” effects captured, according to one embodiment of the invention;

FIG. 8 illustrates a simplified example of product structures captured, according to one embodiment of the invention;

FIG. 9 illustrates a simplified diagram of the NanoPlanner architecture parameter phase, according to one embodiment of the invention;

FIGS. 10A-J illustrate a simplified set of example tables as may be used with the NanoPlanner architecture, according to one embodiment of the invention;

FIG. 11A-B illustrate simplified diagrams of a NanoPlanner architecture optimize phase, according to one embodiment of the invention;

FIG. 12 illustrates a simplified graph comparing CPU processing time to optimization level, according to one embodiment of the invention; and,

FIG. 13 illustrates a simplified diagram of NanoPlanner architecture learn phase, according to one embodiment of the invention.

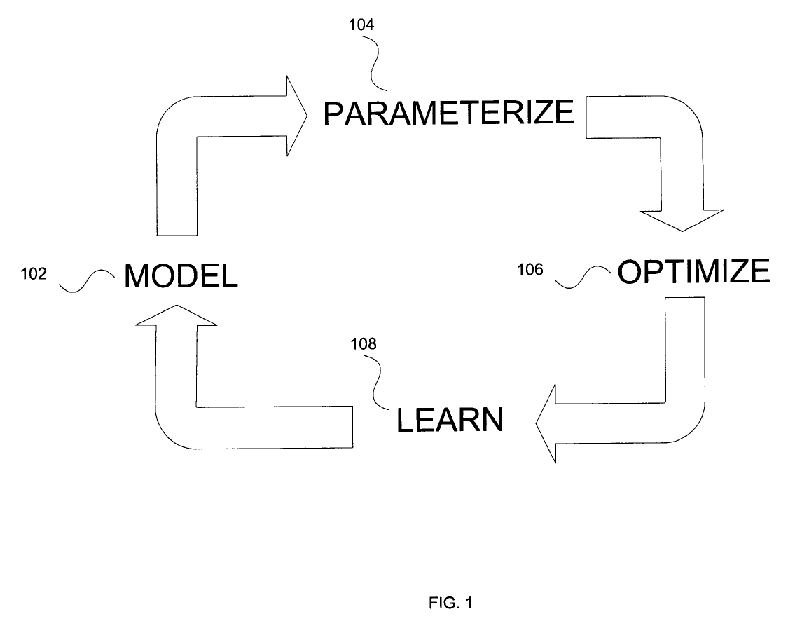

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

In accordance with one embodiment of the present invention, an architecture and methods for optimizing business planning in which a business model generated and optimized in a substantially automated manner, and in which potential projects are prioritized also in a substantially automated manner. This architecture, called the Pometrics NanoPlanner, allows a substantially complete model of the business organization's products and processes to be created, and subsequently adjusted with actual and forecasted business data. This model is then optimized in a substantially automatic fashion in order to create sets of proposed projects that potentially optimize the business organization's revenues.

Unlike most existing business optimization approaches, the current invention can substantially capture a business organization's “nanoeconomics.” Nanoeconomics comprise the relationships between and among factors of production, product and process technologies, economies of scale and scope, learning, customers preferences, technology substitution, etc. Sets of nanoeconomic entities further comprise a subset of the microeconomics of markets and firms (e.g., supply and demand curves, competition, industry structure, etc.). Sets of microeconomic entities further impact the macroeconomics of whole economies (e.g., GDP, growth, inflation, unemployment, monetary and fiscal policy, etc.).

By allowing the capture of a business organization's nanoeconomics, profits can be substantially improved by determining and optimizing the underlying nanodynamics (e.g., volume, variety, velocity, volatility, etc.). Optimizing the volume nanodynamic allows better capacity utilization by lowering the cost of sourcing and flow routing. Optimizing the variety nanodynamic allows the elimination of complexity (i.e., components, stock-keeping units or SKUs, models, platforms, etc.) that customers do not value. Optimizing the velocity nanodynamic allows greater responsiveness to demand, more efficient handling, and less working capital. And optimizing the volatility dynamic allows fewer markdowns, less obsolescence, better capacity decisions.

In one embodiment of the present invention, information in the business model can be continuously extracted from data sources without the need for manual queries. In another embodiment, linear optimization is substantially used. In yet another embodiment, mixed-integer optimization is substantially used. In yet another embodiment, quadratic programming optimization is substantially used. In yet another embodiment, nonlinear optimization is substantially used. In yet another embodiment, the optimization problem is divided into a hierarchy of solvable sub-problems.

A. General

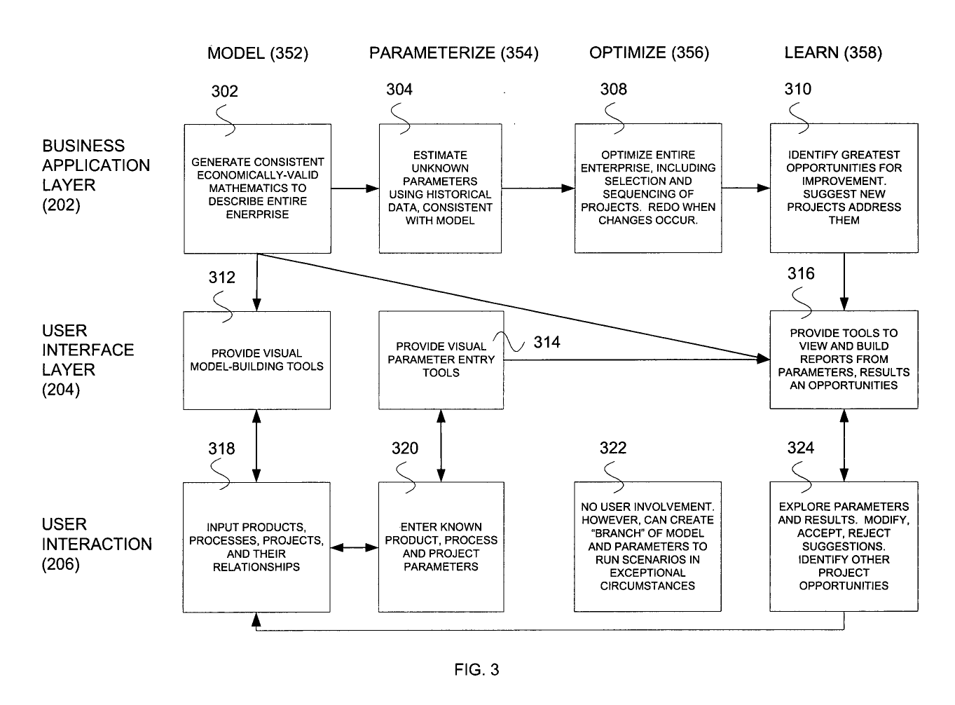

Referring now to FIG. 3, a simplified diagram of a NanoPlanner optimization approach to business planning is shown, according to one embodiment of the present invention. In the model phase 352 of FIG. 3, a model with consistent and economically-valid mathematics is generated to describe entire enterprise from applications in business application layer 302. Unlike most current existing approaches, the model allows the user to define, at a high level, the products, processes and projects and which are interrelated to each other. It automatically generates economically- and physically-valid mathematics to describe those interrelationships. It does not rely on simplistic assumptions as to relationships between and among products and processes. That is, it automatically generates mathematical relationships that are more complex than simple linear associations. Visual model-building tools, included as part of the NanoPlanner architecture or provided by other applications in user-interface layer 302, are used by users to input products, processes, projects and their interrelationships 318 into the model generator.

In the parameterize phase 354, unlike most current existing approaches, the NanoPlanner architecture itself may estimate unknown parameters, including parameters describing “hidden” dynamics, using historical data, consistent with model. Visual parameter entry tools, included as part of the NanoPlanner architecture or provided by other applications in business application layer 304, are used by users input parameters for products, processes, projects 318 into the generated model.

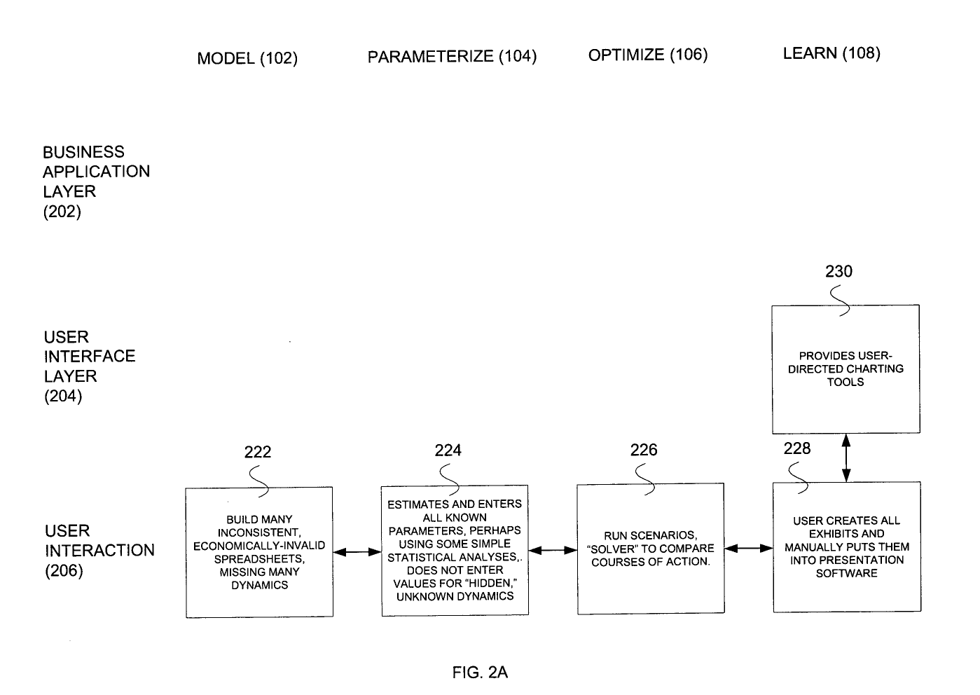

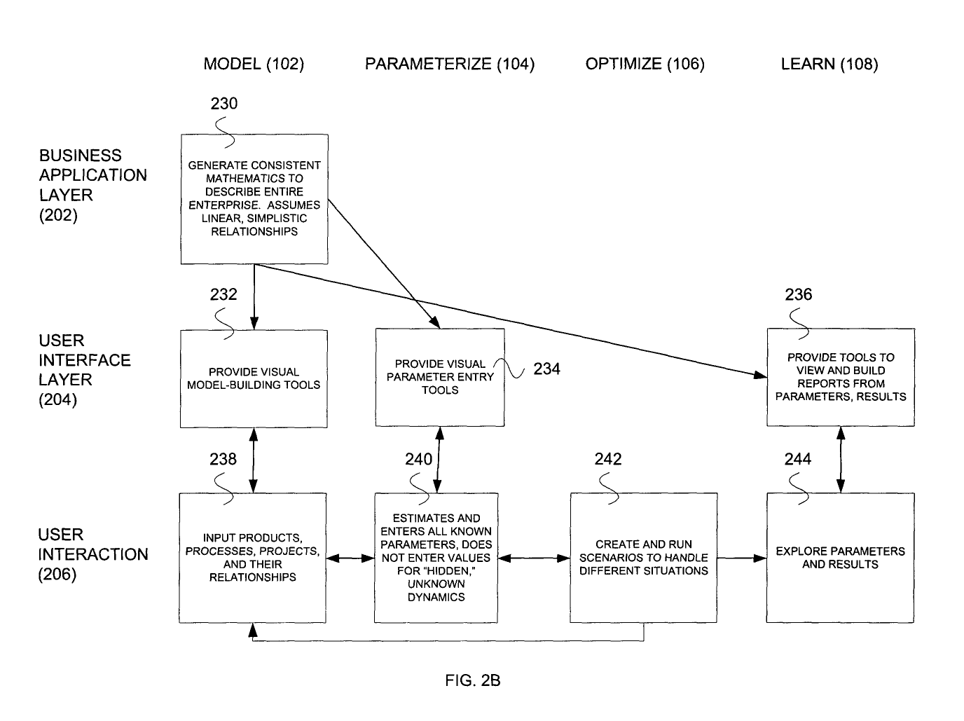

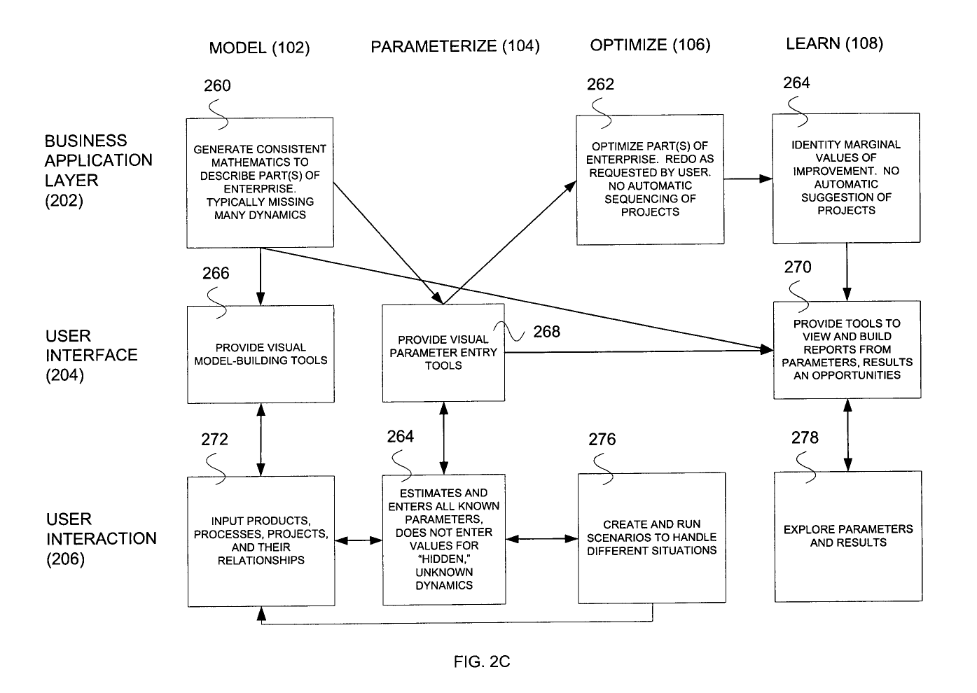

In optimize phase 356, unlike in FIG. 2B, the NanoPlanner architecture optimizes part(s) of enterprise model 308. Unlike most current existing approaches, the entire enterprise is optimized, including the selection and sequencing of projects. The optimization can automatically be redone when changes occur.

Furthermore, there is no substantial user involvement. Users, however, can create a “branch” of model and parameters to run scenarios in exceptional circumstances 322.

In the learn phase 358, the NanoPlanner architecture can identify the greatest opportunities for improvement, and suggest new projects address these opportunities. Visual exploration tools, included as part of the NanoPlanner architecture or provided by other applications in business application layer 310, allow users to view and build reports from parameters, results and opportunities 324. These reports can then be used by users to explore parameters and results; to modify, accept, reject suggestions; and to identify other project opportunities 324.

B. Model Phase

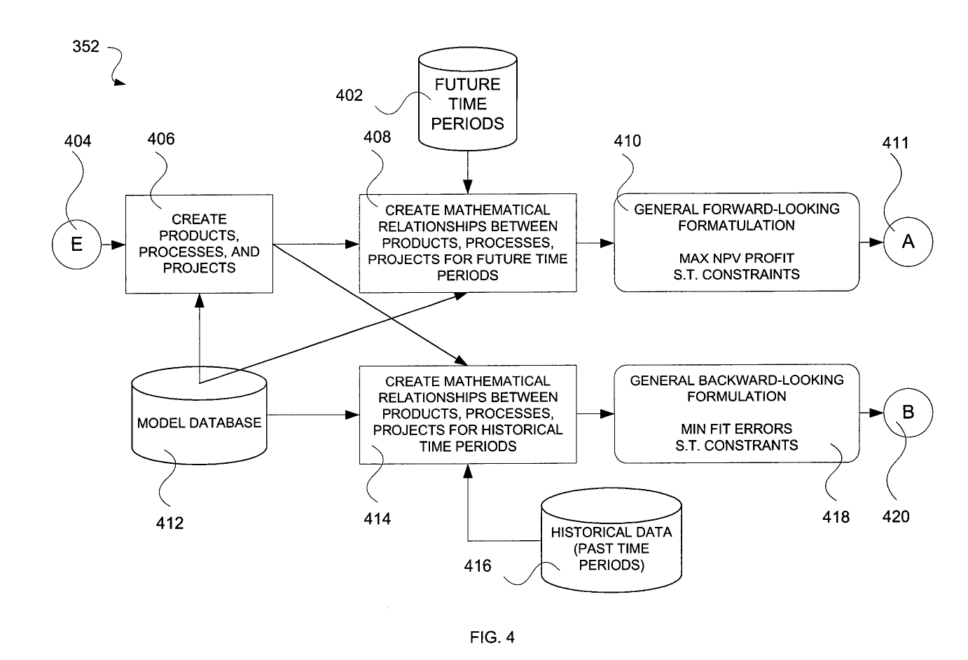

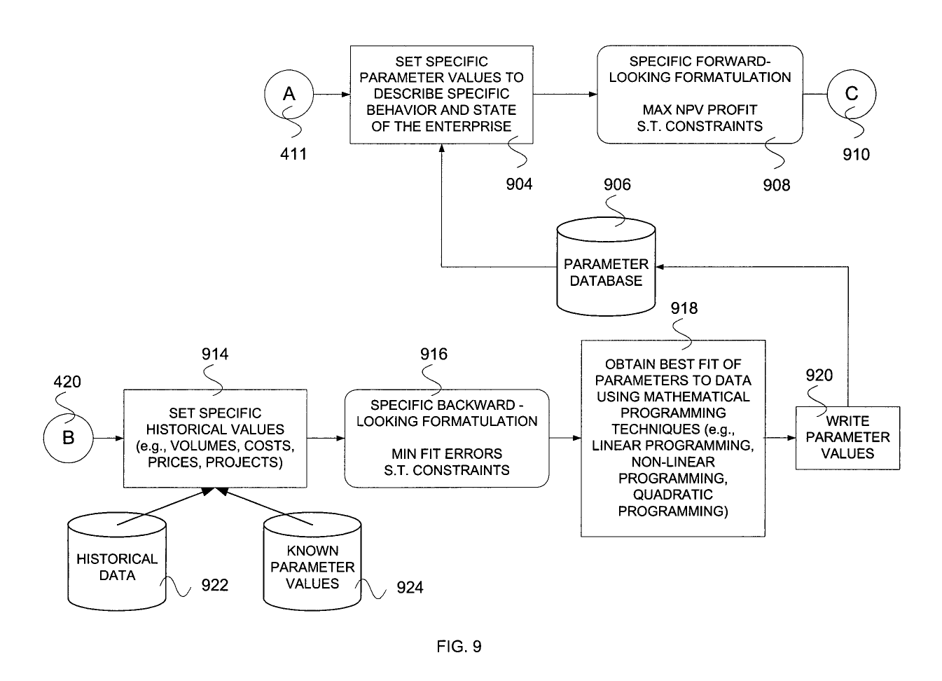

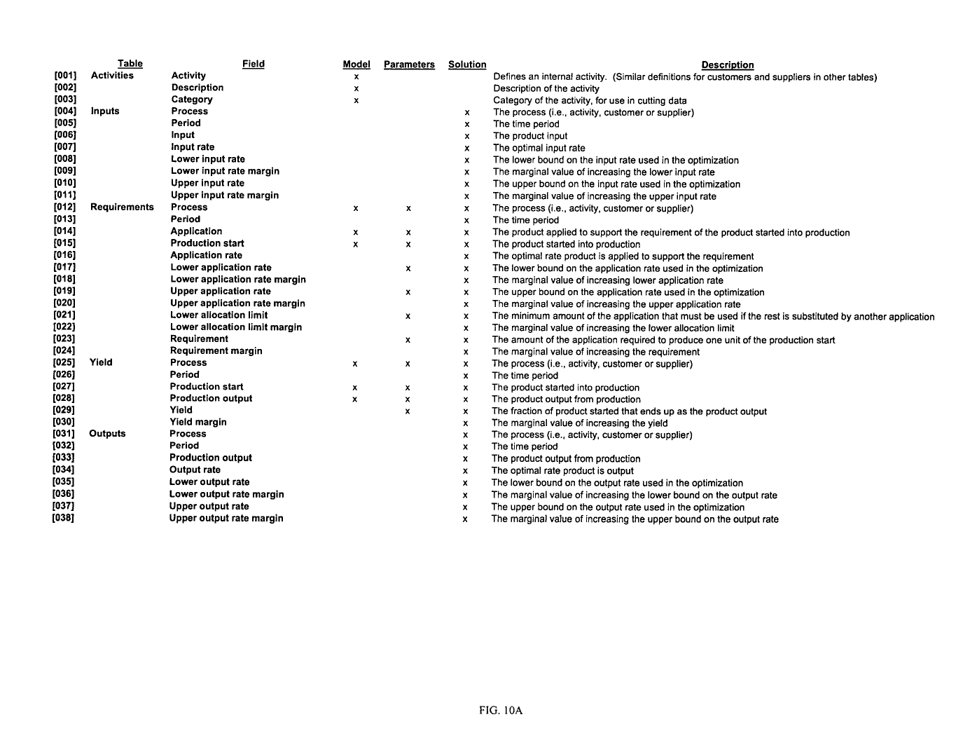

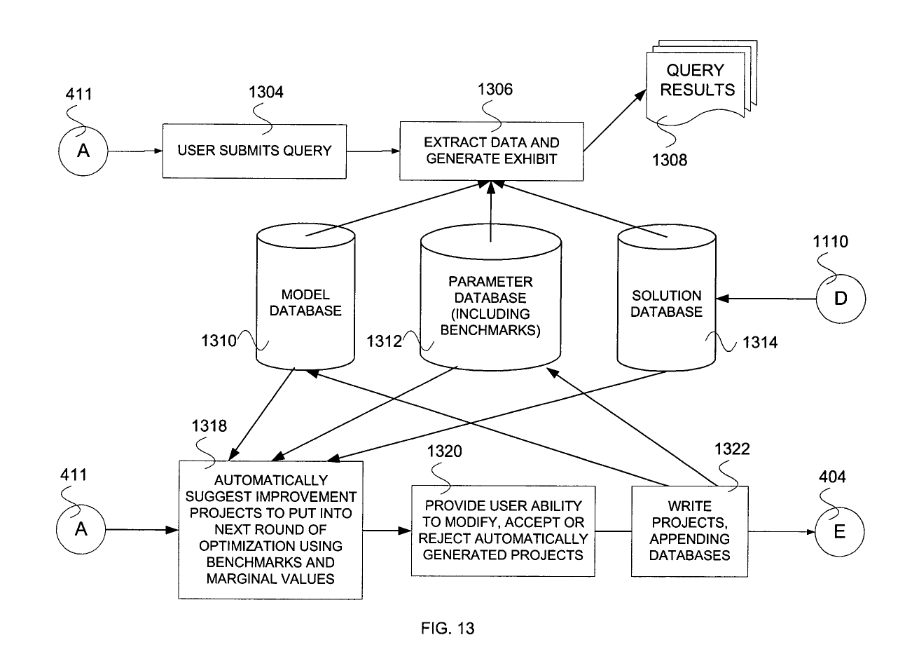

Referring now to FIG. 4, a simplified diagram of NanoPlanner architecture model phase 352 is shown, according to one embodiment of the invention. “E” 404 refers to input previously derived from learn phase 358, as will subsequently be shown in FIG. 13. Initially, a user creates products, processes, and projects 406, in model database 412. The NanoPlanner architecture, in turn, creates mathematical relationships for future time periods between products, processes, projects 408, stored in a database for subsequent user analysis 402. NanoPlanner architecture also creates mathematical relationships for historical time between products, processes, projects 414. This information may be stored in a data warehouse or other database application 416. General forward-looking formulations are then created, such as maximize Net Present Value (NPV) of profit subject to (s.t.) various constraints 410. “A” 411 refers to forward-looking output derived from model phase 352, that may subsequently be used in parameterize phase 354, optimize phase 356 and learn phase 358, as shown in FIG. 13. General backward-looking formulations are also created based on constraints, such as minimize fit errors and s.t. constraints 418. “B” 420 refers to forward-looking output derived from model phase 352, that may subsequently be used in parameterize phase 354, as shown in FIG. 9.

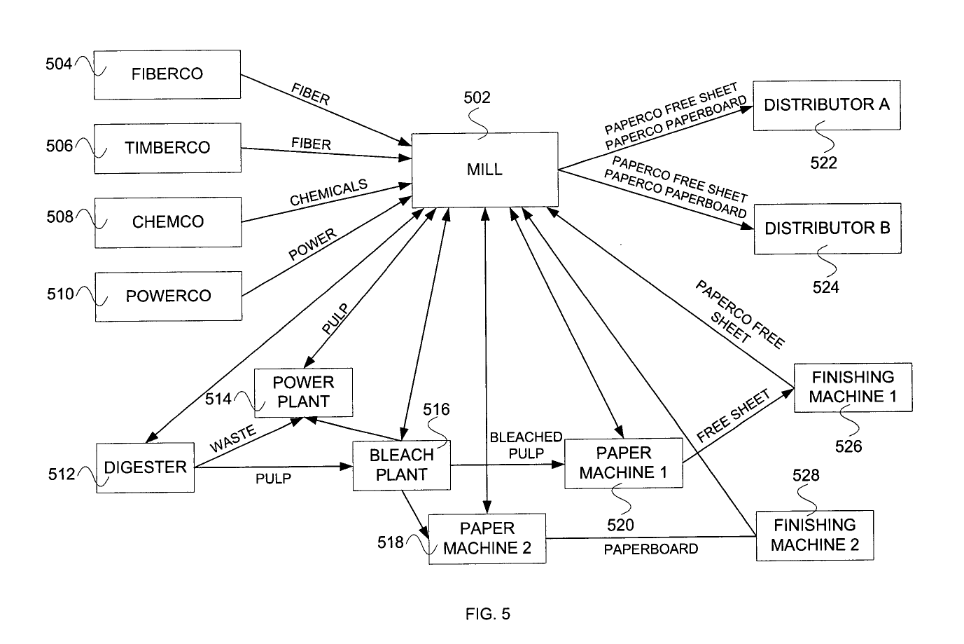

Referring now to FIG. 5, a simplified, high-level example of a model in which key processes and product flows for a paper company mill 502 is shown, according to one embodiment of the invention. Normally raw material can come into the mill as whole logs, sawmill residual, chips, or fiber. In the pulping process, the raw materials are cooked at a certain temperature, under a certain pressure, and in the presence of chemicals in a digester. The resulting pulp is then washed, bleached, and sent to a paper machine, and finally a finishing machine, which typically results in the production of finished rolls or paper, or in paperboard.

Referring now to FIG. 5, four external raw material suppliers supply mill 502 with factors of production for the manufacture of paper and paperboard. Fiberco 504 and timberco 506 provide fiber. Chemco 508 provides chemicals, such as bleaching agents. And powerco 510 provides power for mill operation.

Initially, these raw materials are sent (or coupled in the case of power) to digester 512. Any waste or excess pulp is sent to power plant 514 and used as fuel for the generation of electricity. The digester output (pulp) is sent to bleach plant 516 (along with power and chemicals) for bleaching. Once this is complete, the bleached pulp is sent to paper machine 1 520 (for the manufacture of free sheets) and then to finishing machine 1 526 (for the manufacture of the finished paper product), or to paper machine 2 518 (for the manufacture of paperboard) and then to finishing machine 2 528 (for the manufacture of the finished paperboard product). The finished paper and paperboard are then sent to either distributor A 522, or to distributor B 524.

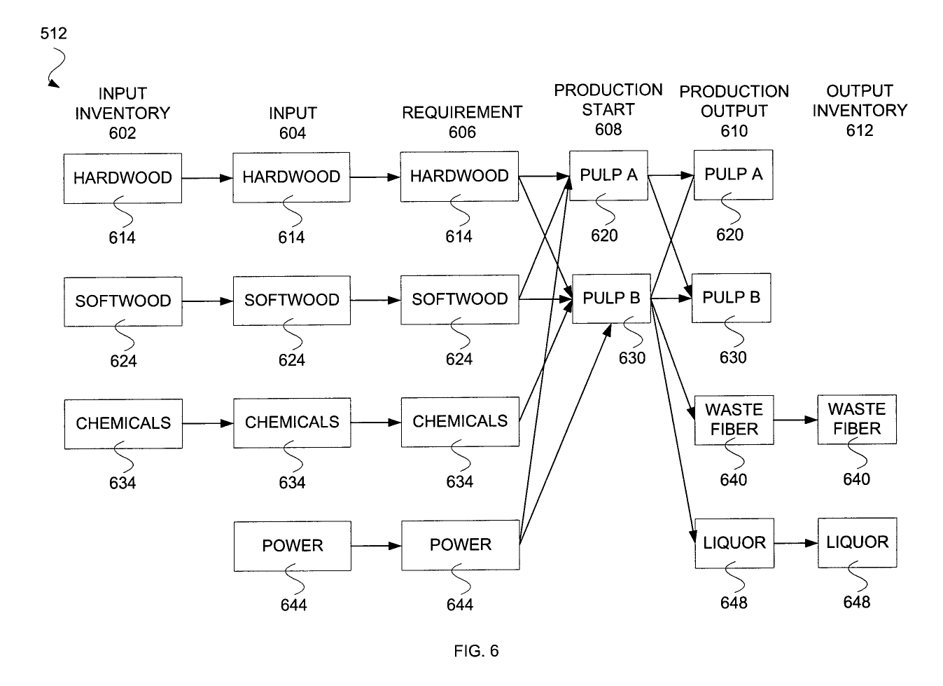

Referring now to FIG. 6, a simplified diagram of the process flow of digester 516 is shown, according to one embodiment of the invention. Digester 516 is configured to for three types of material inventories 602: hardwood 614, softwood 624, and chemicals 634. These material inventories 602, when combined with power 644, compose the total set of inputs that digester 512 can utilize. Depending on the requirements 606 of production start 608, the appropriate subset of input 604 is selected. In this example, the production of both pulp A 620 and pulp B 630 require hardwood 614, softwood 624, chemicals 634, and power 646. Aside from the production output 610 of pulp A 622 and pulp B 632, digester 516 also produces waste fiber 640 and liquor 648, which are allocated to output inventory 612.

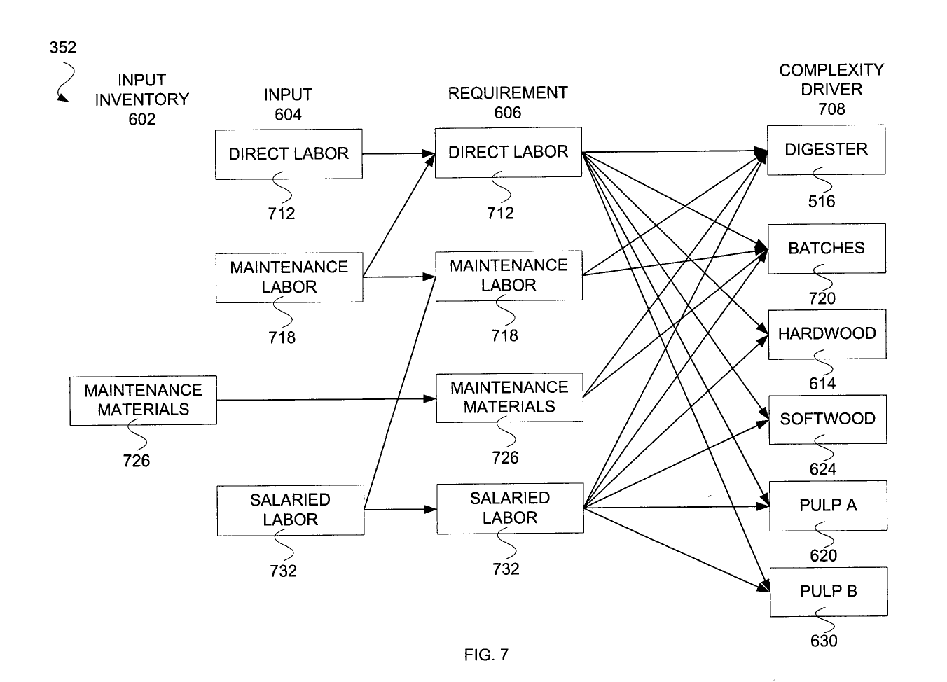

Referring now to FIG. 7, a simplified example of the “complexity” effects captured by model 352 is shown, according to one embodiment of the invention. (These are examples of “hidden” dynamics that many analysts and software approaches miss.) Complexity drivers 708 within model 352 are each composed of a set of requirements 606, which are further drawn from a set of possible inputs 604, which in turn are draw from input inventory 602. For example, digester 516 requires direct labor 712, maintenance labor 718, maintenance materials 726 (e.g., spare parts, grease, etc.), and salaried labor 732 (e.g., managers and supervisors) to sustain it over time. Batches 720, or the aggregation of multiple products and subsequent setup costs, require direct labor 712, maintenance labor 718, maintenance materials 726, and salaried labor 732. The remaining complexity drivers 708 (hardwood 614, softwood 624, pulp A 620, and pulp B 630) each only require direct labor 712 and salaried labor 732 to manage the fact that they are used at digester 516.

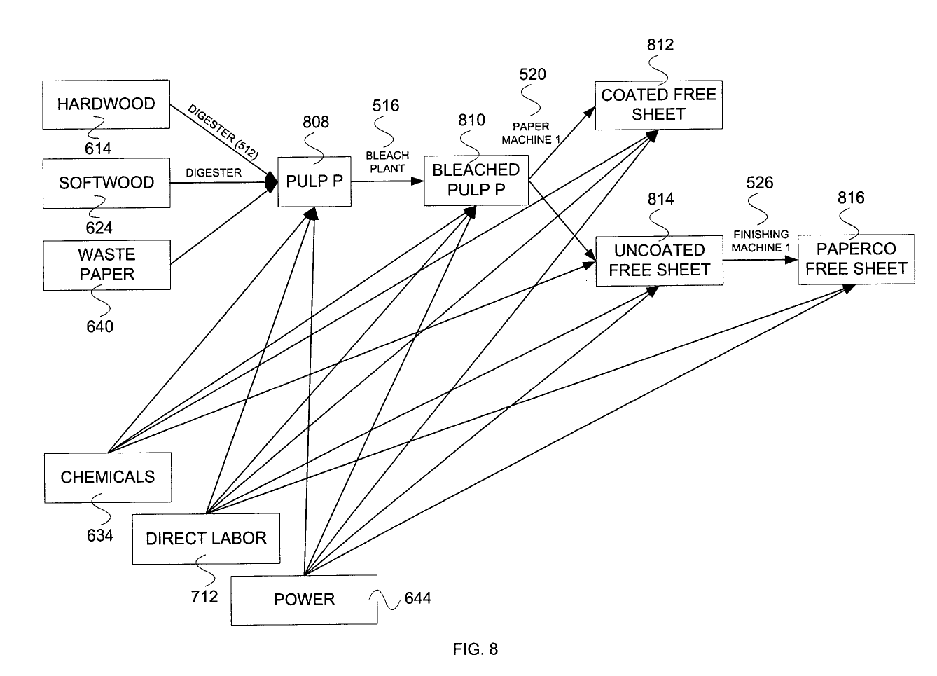

Referring now to FIG. 8, a simplified example of product structures captured by model 352 is shown, according to one embodiment of the invention. In this example, Paperco free sheet 816 is composed of uncoated free sheet 814 that has been processed through finishing machine 1 526, as shown if FIG. 5. Both the processing of coated free sheet 812 and uncoated free sheet 814 each requires bleached pulp P 810, chemicals 634, direct labor 712, and power 644. The creation of bleached pulp P 810 itself requires pulp P 808, chemicals 634, direct labor 712, and power 644. Pulp P 808 requires chemicals 634, direct labor 712, power 644, as well as hardwood 614, softwood 624, and waste paper 640.

The NanoPlanner architecture may automatically generate mathematics for optimization.

A. Indices may be created such as:
1. Process i, i1, i2 ∈{1, . . . , n}≡N≡N_{S}∪N_{A}∪ND, where N_{S} is the set of suppliers, N_{A} is the set of activities and N_{D} is the set of demand centers; N_{S}, N_{A} and N_{D} need not be mutually exclusive
2. Product k, k1, k2, k3, k4 ∈{1, . . . , K}≡K≡K_{M}∪K_{S}, where K_{M} is the set of storable materials and K_{S} is the set of non-storable services; K_{M} and K_{S} are mutually exclusive
3. Project j, j1, j2 ∈{1, . . . , J}≡J≡J_{C}∪J_{D}, where J_{C} is the set of continuous projects whose impacts are proportional to project completion, and J_{D} is the set of discrete projects whose impacts occur at project completionPeriod t∈{0, . . . , T}≡T, where t=0 represents the start of the initial period, where and t=T represents the start of the terminal period

B. Variables and parameters may be created (all variables and parameters are nonnegative unless otherwise indicated):
1. Period parameters
   a. Period duration τₜ—the duration of period t, in years
   b. Discount rate δₜ—the discount rate in period t, in fraction per year (e.g., 0.10 is a discount rate of 10% per year)
2. Enterprise element counts
   a. Process count Nᵢₜ—the count of process i at the start of period t
   b. Product count Kₜ^{k}—the count of product k at the start of period t
3. Unit values
   a. Price pᵢₜ^{k3}—the price of one unit of product k3 accepted by demand center i at the start of period t, in $ per one of product k3's units.
   b. Unit cost cᵢₜ^{k4}—the cost of one unit of product k4 output from supplier i at the start of period t, in $ per one of product k4's units.
4. Flow rates and levels
   a. Inventory input Iᵢₜ^{k}—the level of inventory of material k prior to use by process i at the start of period t, in product k's units.
   b. Input yᵢₜ^{k1}—the rate at which product k1 is input into the process i at the start of period t, in product k1's units per year.
5. Allocation (substitution)
   a. Process allocation (substitution) sNᵢₜ^{k1,k2}—the rate at which product k1 is used to satisfy the requirement of product k2 in supporting process i at the start of period t, in product k2's units per year
   b. Flow allocation (substitution) sᵢₜ^{k1,k2,k3}—the rate at which product k1 is used to satisfy the requirement of product k2 in start production of product k3 at process i at the start of period t, in product k2's units per year
6. Application (requirement)
   a. Process application (requirement) rNᵢₜ^{k2}—the rate at which product is applied to satisfy the requirement of product k2 to sustain process i at the start of period t, in product k2's units per year
   b. Flow application (requirement) rᵢₜ^{k2,k3}—the rate at which product is applied to satisfy the requirement of product k2 for start production of product k3 at process i at the start of period t, in product k2's units per year
   c. Production start fᵢₜ^{k3}—the rate at which production is started of product k3 at process i at the start of period t, in product k3's units per year
   d. Production output \hat{f}ᵢₜ^{k4}—the rate at which product is output of product k4 at process i at the start of period t, in product k4's units per year
   e. Inventory output Îᵢₜ^{k}—the level of inventory of material k subsequent to output by process i at the start of period t, in product k's units
   f. Transfer x_{i1,i2,t}^{k}—the rate at which product k is transferred from process i1 to process i2 at the start of period t, in product k's units per year
7. Flow parameters
   a. Substitutes
      i. Process substitute μsNᵢₜ^{k1,k2}—the units of product k1 that may substitute for one unit of product k2 in supporting process i at the start of period t, in the ratio of units of k1 to the units of k2. If k1=k2 then μsNᵢₜ^{k1,k2}=1.0.
      ii. Flow substitute μsᵢₜ^{k1,k2,k3}—the units of product k1 that may substitute for one unit of product k2 in producing product k3 at process i at the start of period t, in the ratio of units of k1 to the units of k2. If k1=k2 then μsᵢₜ^{k1,k2,k3}=1.0.
b. Requirements
   i. Process requirement αNᵢₜ^{k2}—the units of product k2 required to sustain one unit of process i at the start of period t, in the ratio of units of k2 to the units of i
   ii. Start requirement αfᵢₜ^{k2,k3}—the units of product k2 required for each unit of product k3 started into production at process i at the start of period t, in the ratio of units of k2 to the units of k3
      iii. Overhead requirement αyᵢₜ^{k1,k1′}—the units of product k1 required to support each unit of product k1′ input into process i at the start of period t, in the ratio of units of k1 to the units of k1′, k1≠k1′
      iv. Production duration τfᵢₜ^{k3}—the time required to produce one unit of k3 at one unit of process i
v. Yield ψfᵢₜ^{k3,k4}—the average units of product k4 produced when attempting to produce one unit of product k3 at process i at the start of period t, in the ratio of the units of k4 to the units of k3
c. Bounds
i. Lower bound for any variable denoted by putting a horizontal bar below a variable; e.g., yᵢₜ^{k1}
ii. Upper bound for any variable denoted by putting a horizontal bar above a variable; e.g., \overline{y}ᵢₜ^{k1}

C. Objective
1. Coefficients:
   a. Cash flow χₜ
   b. Financing φₜ
2. Objective terms
   a. Revenue χₜpᵢₜ^{k1}yᵢₜ^{k1} i∈D
   b. Cost −χₜcᵢₜ^{k4}\hat{f}ᵢₜ^{k4} i∈S

D. Constraints
1. Input inventory balance. Ensures that an input product's end of period inventory level equals the start of period inventory level plus the transfers from other processes minus the inputs to the process. If the product is a service, then the inventory levels are defined to be equal to zero.
a. Steady state flows. Assumes flow rates are constant throughout the time period. Appropriate for time periods of very short duration where projects, production rate changes, demand changes, etc. are unlikely to have significant impacts.

$${I}_{i1 , t + 1}^{k} = {I}_{i1 , t}^{k} + {τ}_{t} {\sum }_{i2}^{} {x}_{i2 , i1 , t}^{k} - {τ}_{t} {y}_{i1 , t}^{k} \qquad ( 0.1 )$$
b. Linearflow changes. Assumes flow rates ramp from the start of period flow rates to the end of period flow rates. Appropriate for time periods where projects, production rate changes, demand changes, etc. are likely to have noticeable impacts.

$${I}_{i1 , t + 1}^{k} = {I}_{i1 , t}^{k} + \frac{1}{2} {τ}_{t} {\sum }_{i2} ( {x}_{i2 , i1 , t}^{k} + {x}_{i2 , i1 , t + 1}^{k} ) - \frac{1}{2} {τ}_{t} ( {y}_{i1 , t}^{k} + {y}_{i1 , t + 1}^{k} ) \qquad ( 0.2 )$$
2. Allocation. Ensures that the input of a product equals the allocation of that input to satisfy production requirements, process requirements and overhead requirements (in order of the terms).

$${y}_{it}^{k1} = {\sum }_{k3} {\sum }_{k2} {μs}_{it}^{k1 , k2 , k3} {s}_{it}^{k1 , k2 , k3} + {\sum }_{k2} μ {sN}_{it}^{k1 , k2} {sN}_{it}^{k1 , k2} + {\sum }_{k1 \neq k1 '} α {y}_{it}^{k1 , k1 '} {y}_{it}^{k1 '} \qquad ( 0.3 )$$
3. Application
a. Process application. Ensures that the allocations required to sustain a process are applied to meet that requirement.

$${\sum }_{k1} {sN}_{it}^{k1 , k2} = {rN}_{it}^{k2} \qquad ( 0.4 )$$
b. Flow application. Ensures that the allocations to satisfy a production requirement are applied to meet that requirement.

$${\sum }_{k1} {s}_{it}^{k1 , k2 , k3} = {r}_{it}^{k2 , k3} \qquad ( 0.5 )$$
4. Requirement
   a. Process requirement. Establishes aproduct's requirement to support the process.
      rNᵢₜ^{k2}=αNᵢₜ^{k2}Nᵢₜ (0.6)
   b. Flow requirement. Establishes a product's requirement to support the production start rate.
      rᵢₜ^{k2,k3}=αfᵢₜ^{k2,k3}fᵢₜ^{k3} (0.7)
5. Capacity. Producing a unit of a product takes time. Ensure that the time taken does not exceed the time available.

$${\sum }_{k3} τ {f}_{it}^{k3} {f}_{it}^{k3} \leq {N}_{it} \qquad ( 0.8 )$$
6. Yields
a. Yield. When production of a product is started, other products may be (usually inadvertently) produced. Ensures that the production that actually results from production starts equals the production output.

$${\sum }_{k3} ψ {f}_{it}^{k3 , k4} {f}_{it}^{k3} = {\hat{f}}_{it}^{k4} \qquad ( 0.9 )$$
b. Yield conservation. All starts must lead to outputs (including scrap).

$${\sum }_{k4} ψ {f}_{it}^{k3 , k4} = 1 \qquad ( 0.10 )$$
7. Output inventory balance. Ensures that an output product's end of period inventory level equals the start of period inventory level plus the production output from the process minus the transfers to other processes. If the product is a service, then the inventory levels are defined to be equal to zero.
a. Steady state flows. Assumes flow rates are constant throughout the time period. Appropriate for time periods of very short duration where projects, production rate changes, demand changes, etc. are unlikely to have significant impacts.

$${\hat{I}}_{i1 , t + 1}^{k} = {\hat{I}}_{i1 , t}^{k} + {τ}_{t} {\hat{f}}_{i1 , t}^{k} - {τ}_{t} {\sum }_{i2} {x}_{i1 , i2 , t}^{k} \qquad ( 0.11 )$$
b. Linearflow changes. Assumes flow rates ramp from the start of period flow rates to the end of period flow rates. Appropriate for time periods where projects, production rate changes, demand changes, etc. are likely to have noticeable impacts.

$${\hat{I}}_{i1 , t + 1}^{k} = {\hat{I}}_{i1 , t}^{k} + \frac{1}{2} {τ}_{t} ( {\hat{f}}_{i1 , t}^{k} + {\hat{f}}_{i1 , t + 1}^{k} ) - \frac{1}{2} {τ}_{t} {\sum }_{i2} ( {x}_{i1 , i2 , t}^{k} + {x}_{i1 , i2 , t + 1}^{k} ) \qquad ( 0.12 )$$
8. Bounds
   Substitution lower sᵢₜ^{k2,k2,k3}≧sᵢₜ^{k2,k2,k3}rᵢₜ^{k2,k3} (0.13)
   Substitution upper sᵢₜ^{k2,k2,k3}≧\overline{s}ᵢₜ^{k2,k2,k3}rᵢₜ^{k2,k3} (0.14)

C. Parameterize Phase

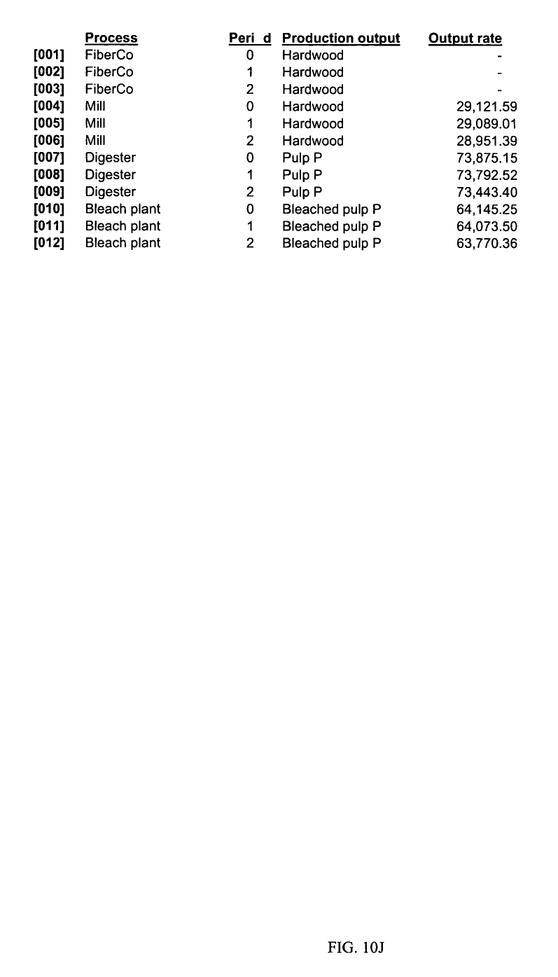

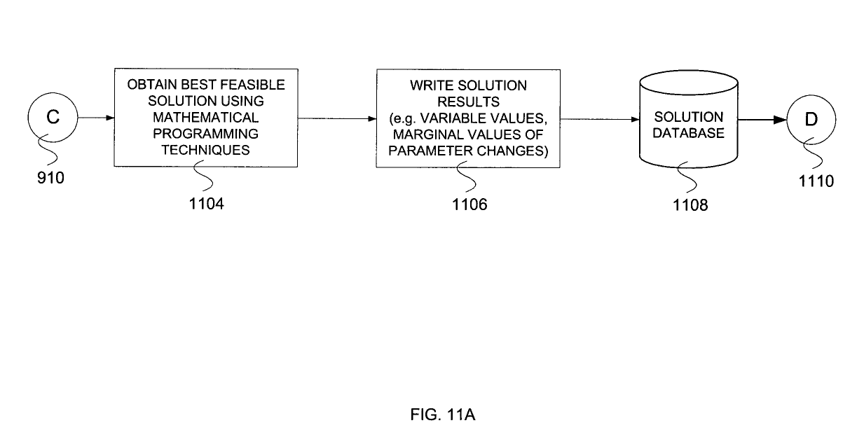

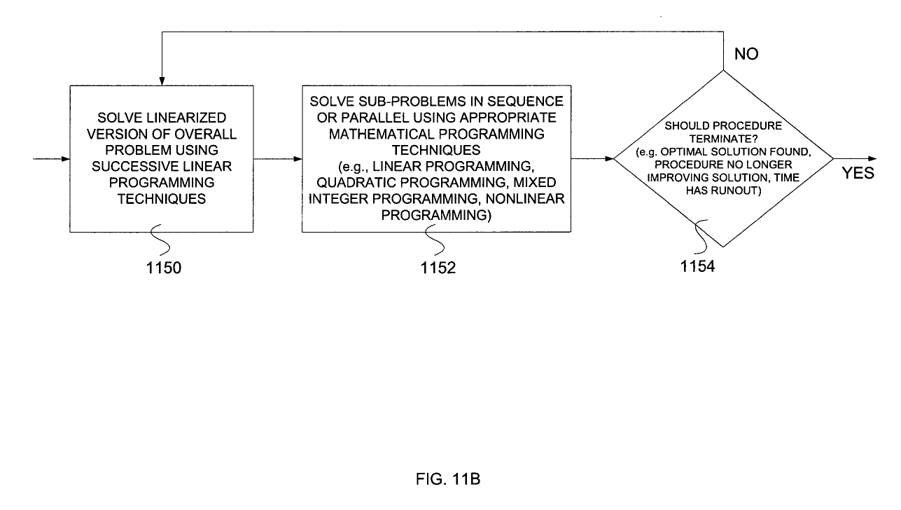

Referring now to FIG. 9, a simplified diagram of the NanoPlanner architecture parameter phase 354 is shown, according to one embodiment of the invention. “A” 411 and “B” 420 refer to inputs previously derived from model phase 352, as described in FIG. 14. Initially, a user sets specific parameter values to describe specific known behavior and state of the enterprise 904. Some of these parameter values can also be extracted from a parameter database 906. The NanoPlanner architecture, in turn, creates specific forward-looking formulation, such as maximize NPV profit subject to constraints 908. “C” 910 refers to forward-looking output derived from parameterize phase 354, that may subsequently be used in optimize phase 356, as shown in FIG. 11.

User may also set specific, known historical values (e.g., volumes, costs, prices, projects) 914. Some of these parameter values can also be extracted from a historical data 922 and known parameter values 924. The NanoPlanner architecture, in turn, obtains a best fit of the remaining, unknown parameters to data using mathematical programming techniques 918 (e.g., linear programming, non-linear programming, quadratic programming). These values may then be written 920 to parameter database 906, used to set specific parameter values to describe specific behavior and state of the enterprise 904. In this way, furthermore, the NanoPlanner can provide estimates for the parameters describing “hidden” dynamics generated by the model phase 352.

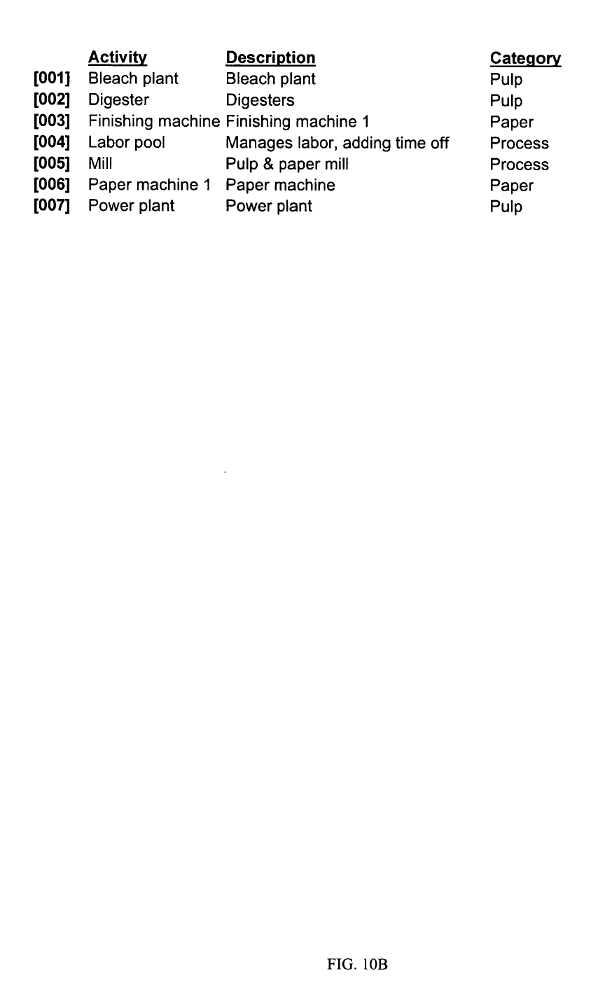

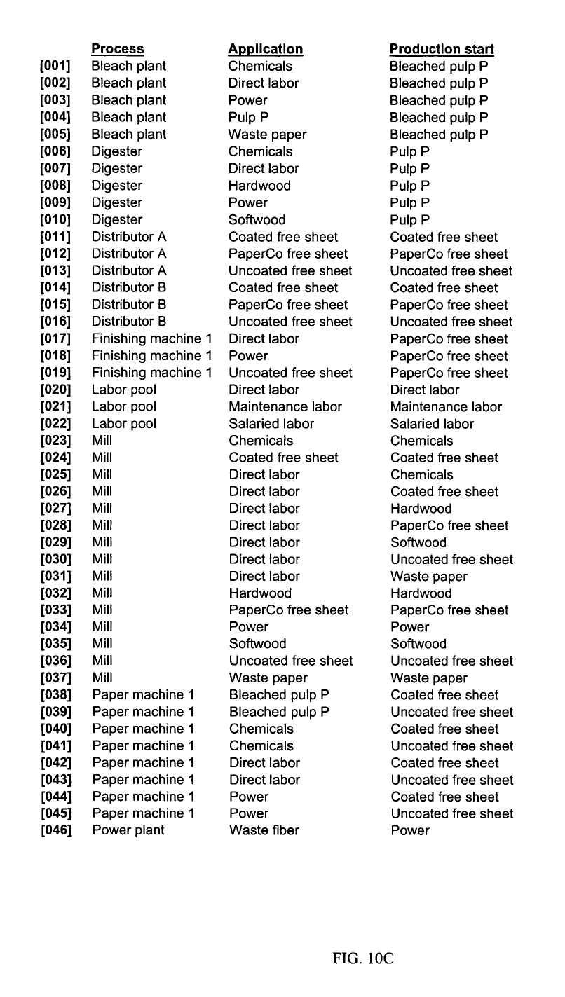

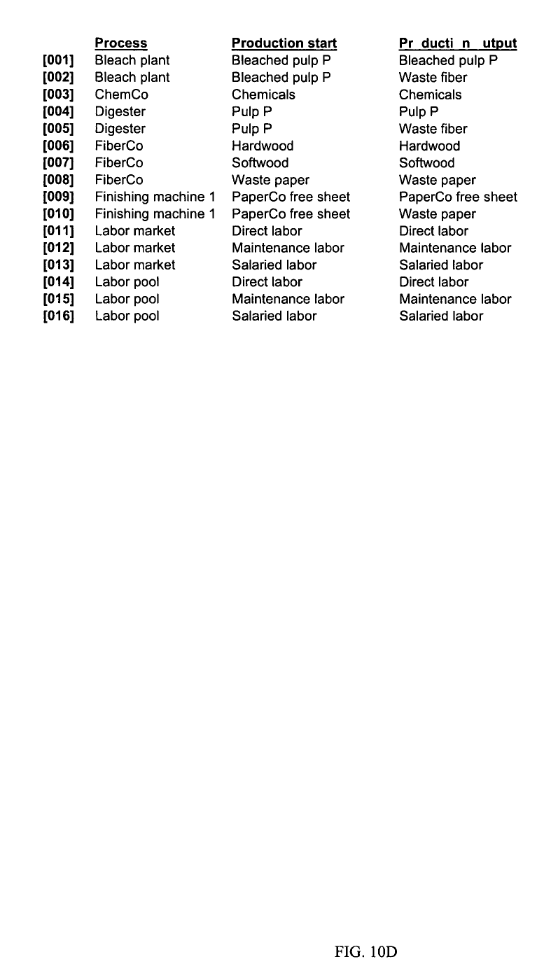

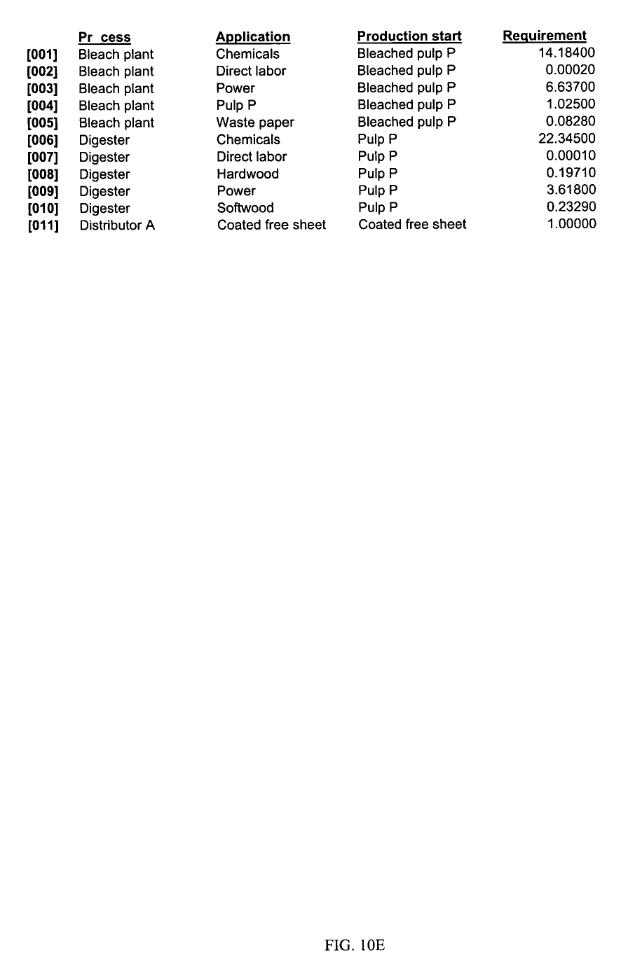

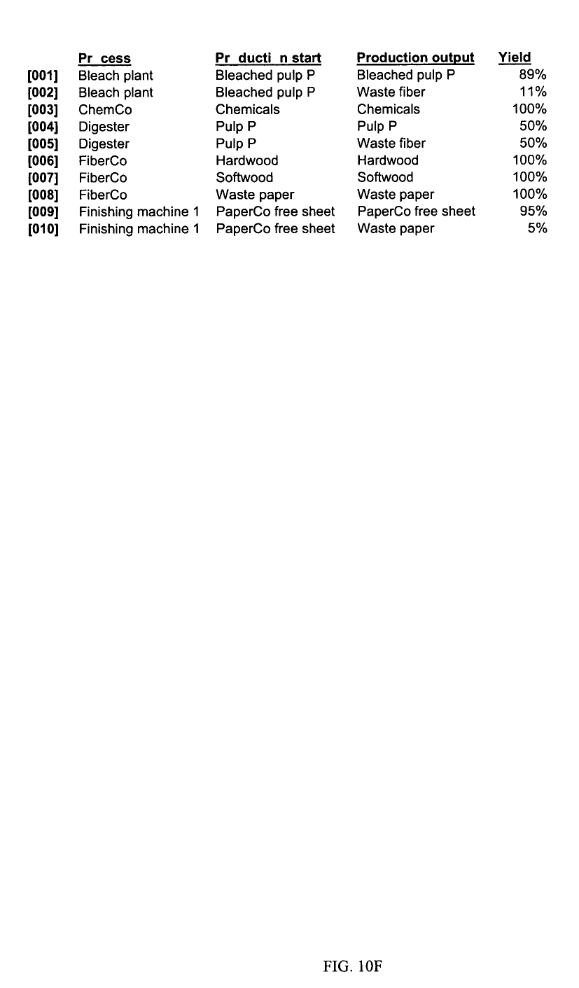

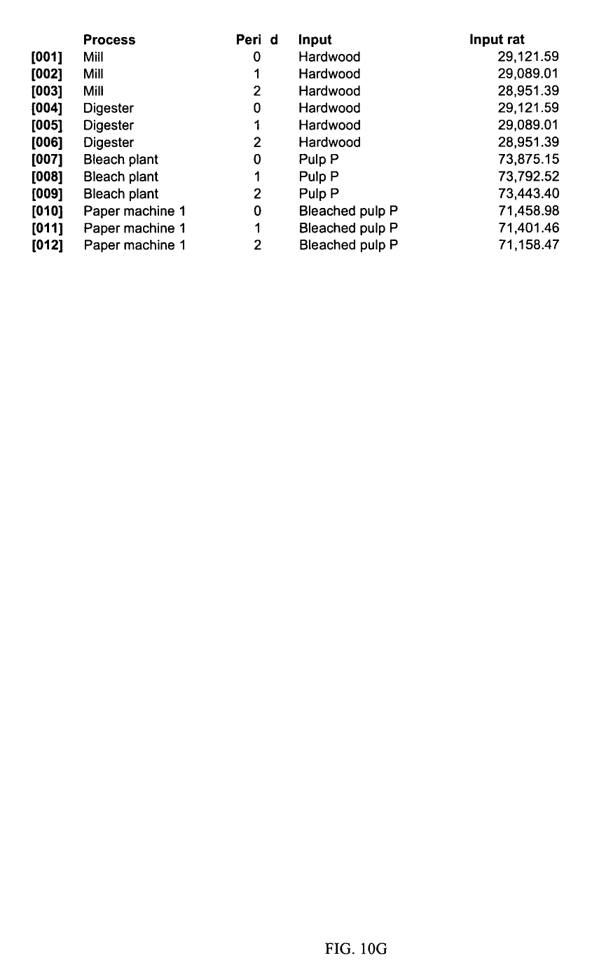

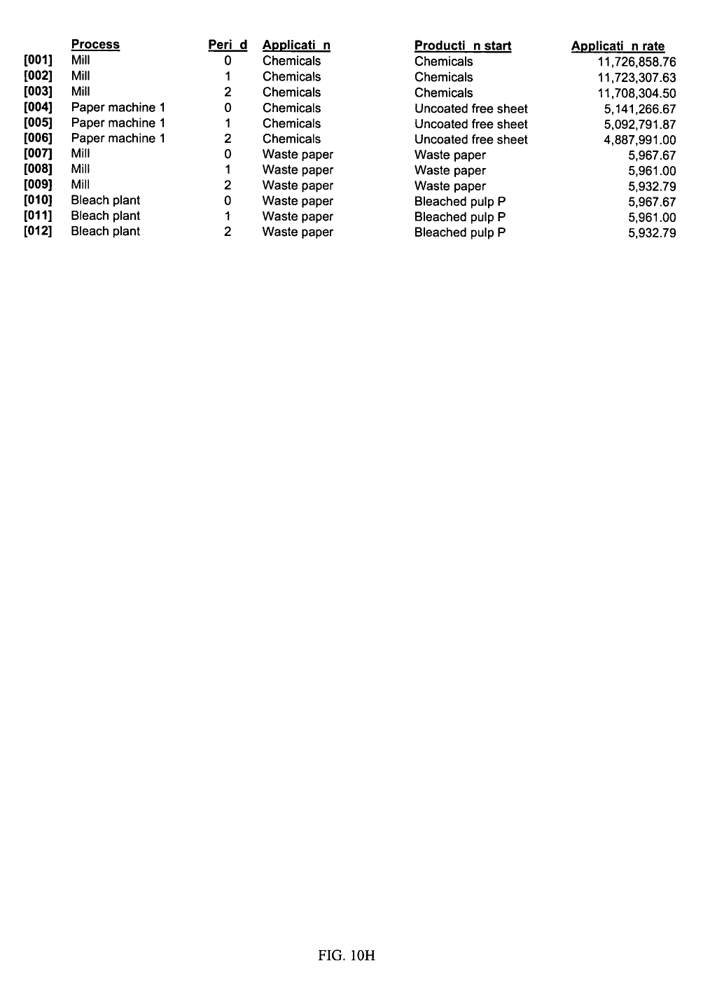

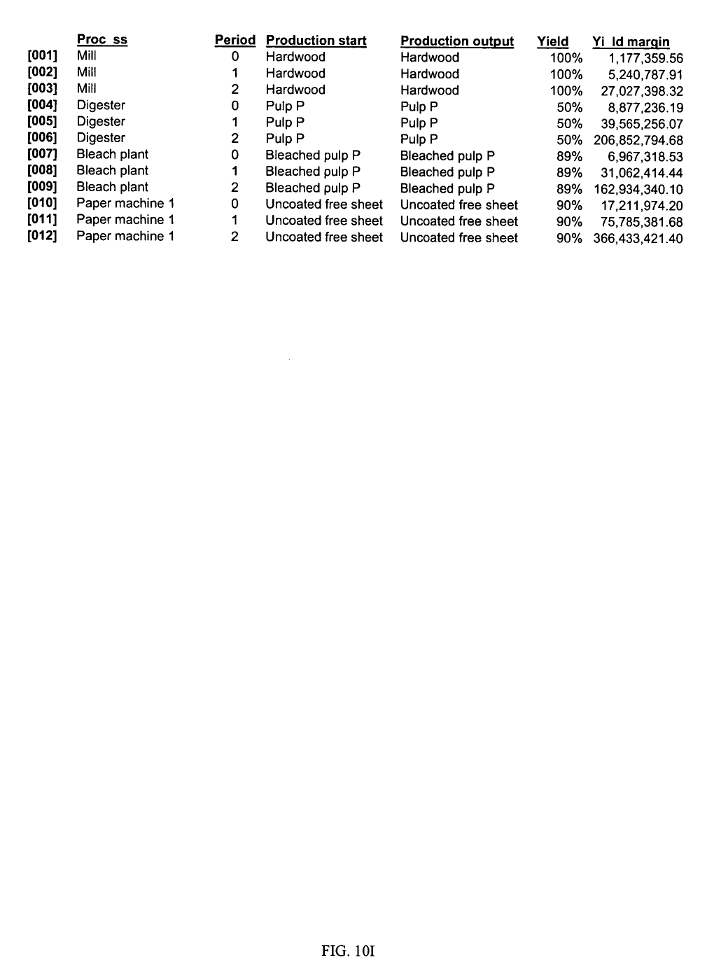

Referring now to FIGS. 10A-I, a simplified set of example tables is shown as may be used with the NanoPlanner architecture, according to one embodiment of the invention. FIG. 10A describes a set of field names and definitions used in the database tables. For example, lines 001-003 comprise fields that describe generic activities. Activity defines an internal activity. There are similar definitions for customers and suppliers in other tables. Description defines a description of the activity. And category defines a category of the activity, for use in cutting data. Lines 004-011 comprise fields that describe model inputs. Process describes the process (i.e., activity, customer or supplier). Period describes the time period. Input describes the product input. Input rate describes the optimal input rate. Lower input rate describes the lower bound on the input rate used in the optimization. Lower input rate margin describes the marginal value of increasing the lower input rate. Upper input rate describes the upper bound on the input rate used in the optimization. And upper input rate margin describes the marginal value of increasing the upper input rate.

Lines 012-024 comprise fields that further describe process requirements. Process describes the process (i.e., activity, customer or supplier). Period describes the time period. Application describes the product applied to support the requirement of the product started into production. Production start describes the product started into production. Application rate describes the optimal rate product is applied to support the requirement. Lower application rate describes the lower bound on the application rate used in the optimization. Lower application rate margin describes the marginal value of increasing lower application rate. Upper application rate describes the upper bound on the application rate used in the optimization. Upper application rate margin describes the marginal value of increasing the upper application rate. Lower allocation limit describes the minimum amount of the application that must be used if the rest is substituted by another application. Lower allocation limit margin describes the marginal value of increasing the lower allocation limit. Requirement describes the amount of the application required to produce one unit of the production start. And requirement margin describes the marginal value of increasing the requirement.

Lines 025-030 comprise fields that further describe yield. Process describes the process (i.e., activity, customer or supplier). Period describes the time period. Production start describes the product started into production. Production output describes the product output from production. Yield describes the fraction of product started that ends up as the product output. Yield margin describes the marginal value of increasing the yield.

Lines 031-038 comprise fields that further describe outputs. Process describes the process (i.e., activity, customer or supplier). Period describes the time period. Production output describes the product output from production. Output rate describes the optimal rate product is output. Lower output rate describes the lower bound on the output rate used in the optimization. Lower output rate margin describes the marginal value of increasing the lower bound on the output rate. Upper output rate describes the upper bound on the output rate used in the optimization. And upper output rate margin describes the marginal value of increasing the upper bound on the output rate.

FIG. 10B describes model activities as shown in FIG. 5, such as bleach plant 516, digester 512, finishing machine 1 526, labor pool, mill 502, paper machine 1 520, power plant 514, according to one embodiment of the invention.

FIG. 10C describes model processes as shown in FIG. 5, according to one embodiment of the invention. Lines 001-005 comprise the applications (e.g., chemicals, direct labor, power, pulp P, and waste paper) and production start (e.g., bleached pulp P) associated with bleach plant 516. Lines 006-010 comprise the applications (e.g., chemicals, direct labor, hardwood, power, softwood) and production start (e.g., pulp P) associated with digester 512. Lines 011-016 comprise the applications (e.g., coated free sheet, paperco free sheet, uncoated free sheet) and production start (e.g., coated free sheet, paperco free sheet, uncoated free sheet) associated with distributor A 522.

Lines 017-019 comprise the applications (e.g., direct labor, power, uncoated free sheet) and production start (e.g., paperco free sheet) associated with finishing machine 1 526. Lines 020-022 comprise the applications (e.g., direct labor, maintenance labor, salaried labor) and production start (e.g., direct labor, maintenance labor, salaried labor) associated with labor. Lines 023-037 comprise the applications (e.g., chemicals, coated free sheet, direct labor, hardwood, paperco free sheet, power, softwood, uncoated free sheet, waste paper) and production start (e.g., chemicals, coated free sheet, direct labor, hardwood, paperco free sheet, power, softwood, uncoated free sheet, waste paper). Lines 038-045 comprise the applications (e.g., bleached pulp P, chemicals, direct labor, power) and production start (e.g., coated free sheet, uncoated free sheet). And line 46 comprises the application (waste fiber) and production start (power).

FIG. 10D describes the production start and production output associated with each model processes as shown in FIG. 5, according to one embodiment of the invention. Lines 001-002 comprise the production starts (e.g., bleached pulp P) and production outputs (e.g., bleached pulp P, waste fiber) associated with bleach plant 516. Line 003 comprises the production start (e.g., chemicals) and production output (e.g., chemicals) associated with chemco 508. And lines 004-005 comprise the production starts (e.g., pulp P) and production outputs (e.g., waste fiber) associated with digester 512.

Lines 006-008 comprise the production starts (e.g., hardwood, softwood, waste paper) and production outputs (e.g., hardwood, softwood, waste paper) associated with fiberco 504. Lines 009-010 comprise the production starts (e.g., paperco free sheet) and production outputs (e.g., paperco free sheet, waste paper) associated with finishing machine 1 526. Lines 011-013 comprise the production starts (e.g., direct labor, maintenance labor, salaried labor) and production outputs (e.g., direct labor, maintenance labor, salaried labor) associated with labor market. And lines 014-016 comprise the production starts (e.g., direct labor, maintenance labor, salaried labor) and production outputs (e.g., direct labor, maintenance labor, salaried labor) associated with labor pool.

FIG. 10E describes the customer requirements of each production start associated the each model processes as shown in FIG. 5, according to one embodiment of the invention. Lines 001-005 comprise application requirements for the production start of bleached pulp P in bleach plant 516 (e.g., 14.184 of chemicals, 0.0002 of direct labor, 6.637 of power, 1.025 of pulp P, and 0.0828 of waste paper). Lines 006-010 comprise application requirements for the production start of pulp P in digester 512 (e.g., 22.345 of chemicals, 0.00010 of direct labor, 0.19710 of hardwood, 3.618 of power, 0.2329 of softwood). And line 011 comprises application requirements for the production start coated free sheet for distributor A 522 (e.g., 1.0 of coated free sheet).

FIG. 10F describes the customer yields of each production output associated the each model processes as shown in FIG. 5, according to one embodiment of the invention. Lines 001-002 comprise yield for the production start of bleached pulp in bleach plant 516 (e.g., 89% bleached pulp P, 11% of waste paper). Line 003 comprises yield for the production start of chemicals in chemco 508 (e.g., 100% of chemicals). Line 004-005 comprises yield for the production start of pulp P in digester 512 (e.g., 50% of pulp P, 50% of waste fiber). Line 006 comprises yield for the production start of hardwood in fiberco 504 (e.g., 100% of hardwood). Line 007 comprises yield for the production start of softwood in fiberco 504 (e.g., 100% of softwood). Line 008 comprises yield for the production start of waste paper in fiberco 504 (e.g., 100% of waste paper). And line 009-010 comprises yield for the production start of paperco free sheet in finishing machine 1 526 (e.g., 50% of paperco free sheet, 5% of waste paper).

FIG. 10G describes the input rates associated with each model process as shown in FIG. 5, according to one embodiment of the invention. Lines 001-003 comprise the input rate for input of hardwood to mill 502 (e.g., 29,121.59 of hardwood in period 0, 29,089.01 of hardwood in period 1, 29,951.39 of hardwood in period 2). Lines 004-006 comprise the input rate for input of hardwood to digester 512 (e.g., 29,121.59 of hardwood in period 0, 29,089.01 of hardwood in period 1, 29,951.39 of hardwood in period 2). Lines 007-009 comprise the input rate for input of pulp P to bleach plant 516 (e.g., 73,875.15 of pulp P in period 0, 73,792.52 of pulp P in period 1, 73,443.40 of pulp P in period 2). And lines 010-011 comprise the input rate for input of bleached pulp P to paper machine 1 520 (e.g., 71,458.98 of bleached pulp P in period 0, 71,401.46 of bleached pulp P in period 1, 71,158.47 of bleached pulp P in period 2).

FIG. 10H describes the application rates associated with each model process as shown in FIG. 5, according to one embodiment of the invention. Lines 001-003 comprise the application rate for the application of chemicals to mill 502 (e.g., 11,726,858.76 of chemicals in period 0, 11,726,307.63 of chemicals in period 1, 11,708,304.50 of chemicals in period 2). Lines 004-006 comprise the application rate for the application of chemicals to paper machine 1 520 (e.g., 5,141,266.67 of uncoated free sheet in period 0, 5,092,791.87 of uncoated free sheet in period 1, 4,887,991.00 of uncoated free sheet in period 2). Lines 007-009 comprise the application rate for the application of waste paper to mill 502 (e.g., 5,967.67 of waste paper in period 0, 5,961.00 of waste paper in period 1, 5,932.79 of waste paper in period 2). And lines 0010-012 comprise the application rate for the application of waste paper to bleached plant 516 (e.g., 5,967.67 of bleached pulp P in period 0, 5,961.00 of bleached pulp P in period 1, 5,932.79 of bleached pulp P in period 2).

FIG. 101 describes the yield and yield margin associated with each model process as shown in FIG. 5, according to one embodiment of the invention. Lines 001-003 comprise the yield and yield margin for the production start of hardwood to mill 502 (e.g., 100% yield for a 1,177,359.56 yield margin of hardwood in period 0, 100% yield for a 5,240,787.91 yield margin of hardwood in period 1, 100% yield for a 27,027,398.32 yield margin of hardwood in period 2). Lines 004-006 comprise the yield and yield margin for the production start of pulp P to digester 512 (e.g., 50% yield for a 8,877,236.19 yield margin of pulp P in period 0, 50% yield for a 39,565,256.07 yield margin of pulp P in period 1, 50% yield for a 206,852,794.68 yield margin of pulp P in period 2).

Lines 007-009 comprise the yield and yield margin for the production start of bleached pulp P to bleach plant 516 (e.g., 89% yield for a 6,967,318.53 yield margin of bleached pulp P in period 0, 89% yield for a 31,062,414.44 yield margin of bleached pulp P in period 1, 89% yield for a 162,934,340.10 yield margin of bleached pulp P in period 2). And lines 010-0 comprise the yield and yield margin for the production start of uncoated free sheet to paper machine 1 520 (e.g., 90% yield for a 17,211,974.20 yield margin of uncoated free sheet in period 0, 90% yield for a 75,785,381.68 yield margin of uncoated free sheet in period 1, 90% yield for a 366,433,421.40 yield margin of uncoated free sheet in period 2).

FIG. 10J describes the output rate associated with each model process as shown in FIG. 5, according to one embodiment of the invention. Lines 001-003 comprise the output rate for the production output of hardwood from fiberco 504 (e.g., 0 in period, 0 in period 1, 0 in period 2). Lines 004-006 comprise the output rate for the production output of hardwood from mill 502 (e.g., 29,121,59 in period, 29,089.01 in period 1, 28,951.39 in period 2). Lines 007-009 comprise the output rate for the production output of pulp P from digester mill 512 (e.g., 73,875.15 in period 0, 73,792.52 in period 1, 73,443.40 in period 2). And, lines 010-012 comprise the output rate for the production output of bleached pulp P from bleach plant 516 (e.g., 64,145.25 in period 0, 64,073.50 in period 1, 63,770.36 in period 2).

D. Optimize Phase

Referring now to FIG. 11A, a simplified diagram of NanoPlanner architecture optimize phase 354 is shown, according to one embodiment of the invention. “C” 910 refers to input previously derived from parameterize phase 356, as shown in FIG. 9. Initially, the NanoPlanner architecture obtains the substantially best feasible solution using mathematical optimization techniques 1104. These solutions results (e.g. variable values, marginal values of parameter changes) are written 1106 to a solution database 1108. “D” 1110 refers to the solution results derived from optimize phase 356, that may subsequently be used in learn phase 358, as will be shown in FIG. 13.

Referring now to FIG. 11B, an example of the simplified diagram of FIG. 11A is shown, according to one embodiment of the invention. Initially, the NanoPlanner architecture solves a linearized version of overall problem using successive linear programming techniques 1150. It then solves sub-problems in sequence or parallel using appropriate mathematical optimization techniques (e.g., linear programming, quadratic programming, mixed integer programming, nonlinear programming, genetic algorithms) 1152. If it is determined that the optimization process should not terminate (e.g., optimal solution is not found, the solution is still longer improving, or the processing time has not run out) the process is repeated 1154.

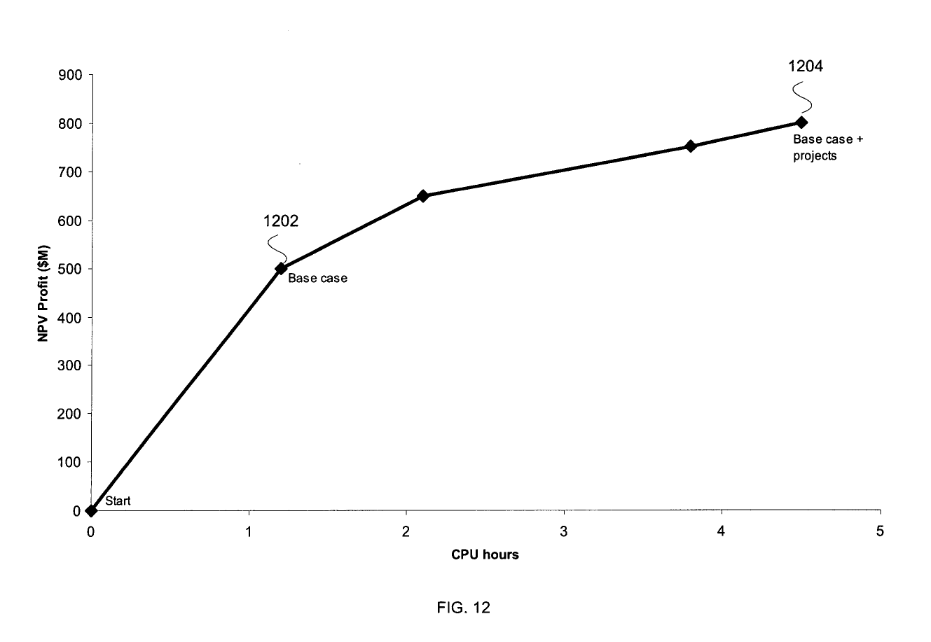

Referring now to FIG. 12, a simplified graph comparing CPU processing time to optimization level is shown, according to one embodiment of the invention. For example, running the optimization for about 1.2 CPU hours yields an NPV profit of about $500M for a base case 1202. Whereas running the optimization for about 4.5 CPU hours yields an NPV profit of about $800M for a base case with selection and sequencing of projects 1204

E. Learn Phase

Referring now to FIG. 13, a simplified diagram of NanoPlanner architecture learn phase 352 is shown, according to one embodiment of the invention. “A” 411 refers to input previously derived from model phase 352, as shown in FIG. 4. “D” 1110 refers to input previously derived from optimize phase 356, as shown in FIG. 11A. Initially, the user submits query 1304. The NanoPlanner architecture then may extract data and generate exhibit 1306 as well as query results 1308. The information may be extracted from the model database 1310, parameter database (including benchmarks) 1312, and solution database 1314.

In a substantially simultaneous manner, the NanoPlanner architecture automatically suggests improvement projects to put into next round of optimization using benchmarks and marginal values 1318. Users are then provided with ability to modify, accept or reject automatically generated projects 1320, and can subsequently write projects, appending databases 1322. “E” 404 refers to the solution results derived from learn phase 358, that may subsequently be used in the next model phase 352, as shown in FIG. 4.

Furthermore, the NanoPlanner architecture further allows a story or presentation composed of exhibits generated from the data to be created. The stories can be pre-scripted, created by a user, or pre-scripted and modified by a user. They may be shared among users. The story exhibits may be updated automatically as the parameters and results change.

While this invention has been described in terms of several preferred embodiments, there are alterations, permutations, and equivalents which fall within the scope of this invention. For example, although reference is given to specific types of optimization techniques (e.g. linear, quadratic, mixed integer, etc) it should be understood that the invention also use other optimization techniques and applications. It should also be noted that there are many alternative ways of implementing the apparatuses of the present invention. Also a business organization can refer to any logical business entity, such as a department, team, or even an entire industry and market. It is therefore intended that the following appended claims be interpreted as including all such alterations, permutations, and equivalents as fall within the true spirit and scope of the present invention.

Advantages of the invention include optimizing business planning in which a business model generated and optimized in a substantially automated manner, and in which potential projects are prioritized also in a substantially automated manner. Other advantages include: allowing the substantial improvement in a business organization's nanodynamics (e.g., volume, variety, velocity, volatility, etc.) and overall profitability; substantially capturing the complicated relationships between products, processes and projects using economically-valid mathematics; and, providing substantial functionality across model, parameterize, optimize and learn with a business application and user-interface. Additional advantages include the substantial ability to use the invention as conditions change and not just when an annual planning cycle dictates; and the identification of opportunities which can subsequently be reviewed, edited and submitted to the model and parameterize stages.

Having disclosed exemplary embodiments and the best mode, modifications and variations may be made to the disclosed embodiments while remaining within the subject and spirit of the invention as defined by the following claims.

1. A method of optimizing the allocation of a set of resources within a business organization, in a substantially automated manner, comprising:
creating a model of a set of products, a set of processes and a set of projects, wherein said business organization comprises said products, said processes and said projects;
creating a set of mathematical relationships between said products, said processes and said projects for a set of time periods;
determining a first set of parameter values to describe said products and said processes and said projects in said model for said set of time periods;
determining a set of substantially optimal allocations of said set of resources using mathematical optimization techniques;
prioritizing said set of a set of substantially optimal allocations based on a business criteria; and, if required, modifying said model with said set of substantially optimal allocations.

2. The method of claim 1, wherein said set of time periods comprises a future time period.

3. The method of claim 1, wherein said set of time periods comprises a historical time period.

4. The method of claim 3, wherein said historical time period is determined, in part, by a second mathematical optimization technique.

5. The method of claim 1, wherein said first mathematical optimization technique comprises solving sub-problems in sequence.

6. The method of claim 1, wherein said first mathematical optimization technique comprises solving sub-problems in parallel.

7. The method of claim 1, wherein said first mathematical optimization technique comprises linear programming.

8. The method of claim 1, wherein said first mathematical programming technique comprises quadratic programming.

9. The method of claim 1, wherein said first mathematical programming technique comprises mixed integer programming.

10. The method of claim 4, wherein said second mathematical programming technique comprises non-linear programming

11. The method of claim 4, wherein said second mathematical programming technique comprises linear programming.

12. The method of claim 4, wherein said second mathematical programming technique comprises quadratic programming.

13. The method of claim 4, wherein said second mathematical programming technique comprises mixed integer programming.

14. The method of claim 1, wherein said second mathematical programming technique comprises non-linear programming.

15. The method of claim 1, wherein said second mathematical programming technique comprises non-linear programming.

16. The method of claim 1, further including the step of creating a story in a substantially automatic manner, comprising said set of products, said set of processes, said a set of projects, and said set of parameters.

17. The method of claim 16, wherein said story is a Microsoft PowerPoint presentation.

18. An apparatus for optimizing the allocation of a set of resources within a business organization, in a substantially automated manner, comprising:
a means for creating a model of a set of products, a set of processes and a set of projects, wherein said business organization comprises said products, said processes and said projects;
a means for creating a set of mathematical relationships between said products, said processes and said projects for a set of time periods;
a means for determining a first set of parameter values to describe said products and said processes and said projects in said model for said set of time periods;
a means for determining a set of substantially optimal allocations of said set of resources using mathematical optimization techniques;
a means for prioritizing said set of a set of substantially optimal allocations based on a business criteria; and, if required,
a means for modifying said model with said set of substantially optimal allocations.

19. The apparatus of claim 18, wherein said set of time periods comprises a future time period.

20. The apparatus of claim 18, wherein said set of time periods comprises a historical time period.

21. The apparatus of claim 3, wherein said historical time period is determined, in part, by a second mathematical optimization technique.

22. The apparatus of claim 18, wherein said first mathematical optimization technique comprises solving sub-problems in sequence.

23. The apparatus of claim 18, wherein said first mathematical optimization technique comprises solving sub-problems in parallel.

24. The apparatus of claim 18, wherein said first mathematical optimization technique comprises linear programming.

25. The apparatus of claim 18, wherein said first mathematical programming technique comprises quadratic programming.

26. The apparatus of claim 18, wherein said first mathematical programming technique comprises mixed integer programming.

27. The apparatus of claim 21, wherein said second mathematical programming technique comprises non-linear programming

28. The apparatus of claim 21, wherein said second mathematical programming technique comprises linear programming.

29. The apparatus of claim 21, wherein said second mathematical programming technique comprises quadratic programming.

30. The apparatus of claim 21, wherein said second mathematical programming technique comprises mixed integer programming.

31. The apparatus of claim 18, wherein said second mathematical programming technique comprises non-linear programming.

32. The apparatus of claim 18, wherein said second mathematical programming technique comprises non-linear programming.

33. The apparatus of claim 18, further including the step of creating a story in a substantially automatic manner, comprising said set of products, said set of processes, said a set of projects, and said set of parameters.

34. The apparatus of claim 16, wherein said story is a Microsoft PowerPoint presentation.
